(19) United States
(12) Patent Application Publication
(10) Pub. No.: US 2008/0163872 A1
(43) Pub. Date: Jul. 10, 2008

(54) Device For Administering a Breathing Gas and Method For Adjusting Breathing Gas Pressures That Alternate at Least in Some Phases

(75) Inventors: Claus Negele, Munchen (DE); Knut Jochle, Schondorf (DE); Rainer Jakobs, Munchen (DE)

Correspondence Address: NIXON & VANDERHYE, PC, 901 NORTH GLEBE ROAD, 11TH FLOOR, ARLINGTON, VA, 22203, US

(73) Assignee: MAP Medizin-Technologie GmbH, Martinsried (DE)

(21) Appl. No.: 11/885,344

(22) PCT Filed: Mar. 6, 2006
(86) PCT No.: PCT/EP06/02036

§ 371 Date: Aug. 30, 2007

(30) Foreign Application Priority Data
Mar. 4, 2005 (DE) 10 2005 010 488.6
Mar. 6, 2006 (EP) PCT/EP2006/002036

(51) Int. Cl. A62B 7/00

(52) U.S. Cl. 128/204.21

(57) ABSTRACT

A device for furnishing a breathing gas at alternating pressure levels has a feeder to feed the breathing gas, a pressure adjusting device for triggering the feeder set-point breathing gas pressure signal, furnishes the breathing gas at a set-point, a pressure specification device for generating a pressure signal, and parameter-determination unit for furnishing parameters representative of at least of instantaneous pressure (p), progression of time (t), and instantaneous breathing gas flow (v). The pressure specification device includes a computer circuit configured such that, at least in the expiratory phase, pressure is adjusted on the basis of a dynamic or nonlinear pressure guidance function, which takes parameters into account that are indicative of the breathing gas flow and the progression of time. As a result, the tendency to lowering the breathing gas pressure in conjunction with the extent of the breathing gas flow decreases with increasing progression of time.

The invention is directed to a device for administering a breathing gas to a user. The invention is also directed to a method for adjusting the static pressure, prevailing at the user, of the breathing gas to alternating pressure levels that in at least some phases are above the ambient pressure.

Particularly for treating sleep-related breathing problems, it is known to deliver a breathing gas, such as filtered ambient air, to a patient at a pressure level that is elevated above the ambient pressure, via a breathing mask arrangement and a feeding device coupled to it.

By means of a breathing gas pressure that is elevated above ambient pressure, typically in the range of from 4 to 18 mbar, it becomes possible to prevent any obstructions in the region of the upper airways. The reduction in the likelihood that such obstructions will occur in the region of the upper airways during the administration of the breathing gas at an elevated pressure level is based on an effect known as pneumatic splinting. This splinting effect is attained as such as a result of the pressure acting on the airway wall in the region of the upper airways and radially supporting this wall in the process. The level of the pressure required to support obstruction-relevant portions of the airway depends on the physiological status of the user. Particularly in clinical pictures where there is a pronounced constriction of the upper airways, a pressure drop caused by the flow in inspiration because of these constrictions means that an external breathing gas pressure is required, by which adequate airway support is assured even after the inspiratory pressure drop caused by flow resistance in the obstruction-relevant zones is subtracted. During the expiratory phase, because of the flow resistance of the airways, no drop in the supporting pressure is caused, so that in expiration, the tracking effect is as a rule still assured even at a lesser pressure.

To keep the pressure load on the user as low as possible, it is known, for instance by measuring the breathing gas flow, to ascertain whether an expiratory phase or an inspiration phase is occurring at the moment. The breathing gas pressures prevailing at the patient can be varied essentially synchronously with the respiration phases detected, such that in the inspiration phase, the breathing gas pressure is higher than in the expiratory phase. The peak pressure level and the pressure level spacing are typically adapted during examination of the user in a sleep laboratory.

It is possible to vary the pressure of the breathing gas in a defined way. In particular, the breathing gas pressure can be guided in such a way that during the expiratory phases, lower breathing gas pressures prevail than during the inspiration phases. It is also possible to adapt the breathing gas pressure such that an elevated breathing gas pressure or an elevated level difference, for instance, is not regulated until a predetermined startup phase of a therapeutic device or a phase in which the user falls asleep is concluded, or if the person to be provided with breathing support is in a predetermined sleep stage.

The administration of the breathing gas at the pressure levels that are at least intermittently above the ambient pressure can be done via devices which besides a feeding device for feeding the breathing gas, typically formed by a blower, also include a control unit, by which the feeding power of the feeding device is adapted (for instance by regulating the rpm of the blower impeller).

This control unit can be embodied such that a desired pressure regulating characteristic is effected by means of essentially program-based definition of the configuration of the control unit. In a control unit equipped adequately in terms of computation power, it becomes possible to implement relatively complex pressure regulating strategies and by observation of the breathing gas flow signal to draw conclusions about the instantaneous physiological status of the user, and/or to detect the phase of respiration and calculate different set-point pressure levels for the inspiration phase and for the expiratory phase.

In ascertaining the breathing gas pressure, the problem is that setting a pressure level that is advantageous from the standpoint of the mechanics of breathing or therapeutic standpoints or for preventing obstruction is sometimes perceived subjectively by the affected user as not optimal, or as burdensome or even unpleasant.

In the light of this problem, the object of the invention is to provide solutions which make it possible to guide the pressure in a way that is subjectively perceived by the user as pleasant or at least more acceptable, and which take improved account of the mechanics of breathing that are also definitive in terms of an intended therapeutic effect.

In a first aspect of the present invention, this object is attained by a device for furnishing or providing a breathing gas at alternating breathing gas pressure levels that at least in some phases are above the ambient pressure, having:
a feeding device for feeding the breathing gas,
a pressure adjusting device for triggering the feeding device, such that the feeding device, with recourse to a set-point breathing gas pressure signal, furnishes the breathing gas at a set-point breathing gas pressure level,
a pressure specification device for generating the set-point breathing gas pressure signal that is definitive with regard to the set-point breathing gas pressure level, and
parameter-collecting means for furnishing parameters representative at least of the instantaneous breathing gas pressure p, the progression of time t, and the instantaneous breathing gas flow v,
wherein the pressure specification device includes a computer circuit, and the computer circuit is configured such that it adjusts the set-point breathing gas pressure level as a function of the parameters furnished by the parameter-determination means, in such a manner that at least in the expiratory phase, an adjustment of the breathing gas pressure to a pressure level is effected which is calculated on the basis of a dynamic or nonlinear pressure guidance function, which as such takes parameters into account that are indicative of the breathing gas flow and the progression of time and as a result, the tendency to lowering the breathing gas pressure in conjunction with the extent of the breathing gas flow decreases with increasing progression of time.

This nonlinear function is preferably a trigonometric function, or a function approximate to that with a pronounced nonlinear character. In particular, the nonlinear function can be embodied as an arc tangent, sine/cosine, or root function. As a modulation argument, in particular the ratio of the instantaneous breathing gas flow to a reference value can be used. This reference value may be an extreme value of the breathing gas flow of the preceding breath, or a value calculated in some other way, preferably adaptively. As an adaptively calculated value, the average breathing gas flow of the most recent breath, or of a predetermined number of breaths, or of the breaths within a predetermined length of time, is especially suitable.

The function is preferably defined such that after the expiration of a length of time lasting as long as a typical expiratory phase, the potential for pressure reduction is reduced, and is optionally set to zero.

It is also possible, by way of the statement of the invention, after a defined length of time or a length of time calculated by adaptive statements has elapsed to bring about a temporary pressure increase above a basic therapeutic pressure, so that for instance in the event of an undetected expiratory phase, a triggering effect for initiating an inspiration phase is generated. In reliance on a sine characteristic, gentle overswings past the actual basic therapeutic pressure can thus be effected, especially if certain time criteria are met.

By means of the statement of the invention, it advantageously becomes possible, following the fading of an inspiration phase, to bring about a gradual reduction in the breathing gas pressure in a way that is subjectively perceptible as making breathing easier; the extent of the pressure reduction varies over time, such that with increasing time, the pressure reduction potential for the expiratory phase decreases. It becomes furthermore possible to limit both the initial expiratory pressure reduction and the potential for the final expiratory pressure reduction without thresholds that are markedly perceptible to the user, and also, if the end of the expiratory phase is imprecisely detected or if there is persistent leakage, to assure a reliable return to the therapeutic pressure level.

In a special aspect of the present invention, in the dynamic or nonlinear taking into account of the signals indicative of the breathing gas flow, the instantaneous or modelled thermal load of electrical components, or other types of components that set limit temperatures, is considered. By this approach, it becomes possible in particular to fully utilize device states, in which the device components do not yet have an impermissibly high thermal load, to implement highly dynamic regulation if needed. Only if less dynamic regulation is needed on the basis of temperature measurement values or other kinds of conclusions about the thermal load of the device, or if a more-restricted pressure regulation range appears recommended, can corresponding arguments of the pressure regulating function be designed by parameter adaptation, such that a lesser pressure variation potential prevails, or other kinds of lesser pressure variations occur.

By taking the estimated or actual thermal load of critical components of the breathing gas feeding device into account, it becomes possible from time to time to extensively fully utilize the control range, and not to constrict this range until the actual or estimated device load makes that appear necessary. As a result, it becomes possible in particular in an initial activation phase of the device (which then is still cool) to operate over a wide control range and if needed with highly dynamic regulation.

Preferably, the function intended for calculating the set-point pressure level is designed as a summation function, with at least one nonlinear member, or as a nonlinear function with an argument that takes the breathing gas flow into account. In particular, the function can be designed such that both for breathing gas flows below a mean breathing gas flow value and for breathing gas flows above a mean breathing gas flow value, attenuated pressure reduction potentials result. Toward the end of a time period that is typical for an average expiratory phase, the pressure reduction potential can be extensively restricted, set to zero, or even optionally inverted, so that then a slight overelevation of pressure ensues, for instance as an inspiration trigger.

It is possible in the pressure variation to use plottings of the relationship between the breathing gas flow and the breathing gas pressure. On the basis of this relationship, conclusions can be drawn as to whether an obstruction state exists at the moment. From an assessment of the obstruction state, it becomes possible to take the breathing gas pressure level, the variation bandwidth, and other technical regulation characteristics into account. It is also possible in some other way, or in combination with the aforementioned provisions, to draw conclusions about the instantaneous physiological state of the user, and in particular the degree of obstruction at that moment. As respective approaches, particularly statements for evaluating properties of the breathing flow profile that are typical of obstruction or that offer conclusions about motor respiration in other ways are suitable, particularly in combination with the breathing gas pressure that prevails then.

It is also possible to provide or to link the function of the invention with a term or argument by which any leakage states that may exist are detected or advantageously compensated for by regulation. In particular, if there is a markedly increased leakage flow, it is possible to constrict the width of the pressure variation range and to guide the breathing gas pressure largely constantly at a pressure level which is ascertained on the specification of a pressure determination statement designed for leakage states and which corresponds for instance to a minimum CPAP pressure intended for the user.

The term “breathing gas flow” should be understood in the present context to mean the shifted volume per unit of time dictated by respiration. Information about this can be obtained by suitable measurement means, such as differential pressure measurement baffles, dynamic pressure measuring arrangements, or other kinds of measuring arrangements suitable for detecting volumetric flows of gas. From a control standpoint, other kinds of information or signals indicative of the breathing gas flow can be evaluated, such as the electrical power drawn by the breathing gas feeding device. The breathing gas flow, or signals representing it, can also be obtained in other ways, in particular from the blower rpm and from the pressure gradient prevailing at the blower, in a characteristic-diagram- or map-based manner.

In systems with constant flushing, that is, with a continuous diversion of air that may be laden with CO₂ from the region of the mask through flushing openings, a value which as a result is permanently included in the flow signal and which may possibly also slightly vary with changing pressures, can be suitably taken into account, so that the flushing flow is not interpreted as respiration or as inspiration. Ascertaining the flushing flow can be done by computer using suitable models, by forming an integral or a mean value, and is exhibited in the breathing gas flow signal in the form of an offset relative to a zero line.

The detection of the breathing phase can be done by evaluating the breathing gas flow signal, and in particular by evaluating its first derivation, with regard to the attainment of zero points or threshold values. Different statements for respiration phase detection (volume-, curvature-, and slope-based statements, as well as profile-based statements of other kinds) can be combined to enable the most reliable possible detection and discrimination among the respiration phases.

The range of variation of the breathing gas flow can be set into proportion using a suitable reference parameter, so that the variation of the breathing gas flow is within a standardized range, such as from 0 to 1 or from 0 to π; the standardization thus achieved can be further mapped or plotted via a trigonometric function and used to calculate an instantaneous suitable pressure value. The mapping function used in this respect to map the variation in the volumetric flow as a variation in the breathing gas pressure is preferably designed such that within a typical period of time for an expiration, in the range of mean values of the volumetric flow, relatively major pressure changes occur, while conversely the changes decrease with increasing volumetric flows. (Thus, the mapping function is steeper in a middle section than in an initial or end section.) By means of the sine or cosine statement, especially advantageous mapping concepts can be implemented for mapping the expiratory volumetric flow as pressure reduction values. During the expiratory phase, the pressure can be defined for instance on the following statement:

p_{exp(v,t)}=½*p_{base}(1+cos(π*v/vₘₐₓ*(k₂Tᵢₙₛₚ−t)/(k₂*Tᵢₙₛₚ))).

In the equation:

p_{exp(v,t)} stands for expiratory static breathing gas pressure.

p_{base} stands for basic pressure, such as the recommended, static, inspiratory therapeutic pressure.

v stands for the breathing gas flow.

vₘₐₓ stands for the maximum breathing gas flow, optionally the average peak value.

k₂ is an adaptation factor.

Tᵢₙₛₚ is the duration of the inspiration phase, optionally the average value of the preceding respiration cycles.

Further advantageous characteristics, and in particular configuration characteristics of the control unit, are the subject of the dependent claims.

The invention is also directed to the pressure guidance method, which can be performed based on the apparatus of the invention, in general as well as in special features, such as those that result from the recited special apparatus provisions or indications of effects recited in other ways.

Further details and characteristics of the invention will become apparent from the ensuing description in conjunction with the drawing. Shown are:

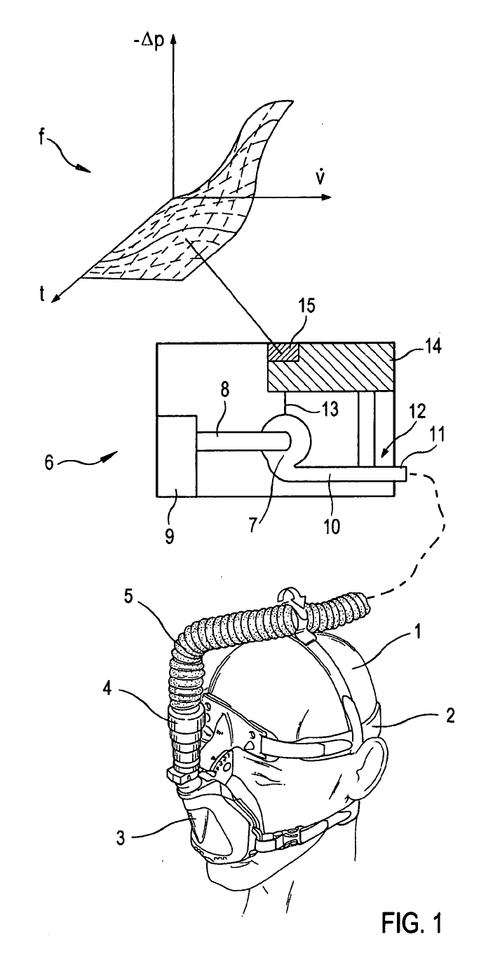

FIG. 1, a sketch for explaining a system according to the invention for delivering a breathing gas at pressure levels that alternate essentially synchronously with respiration;

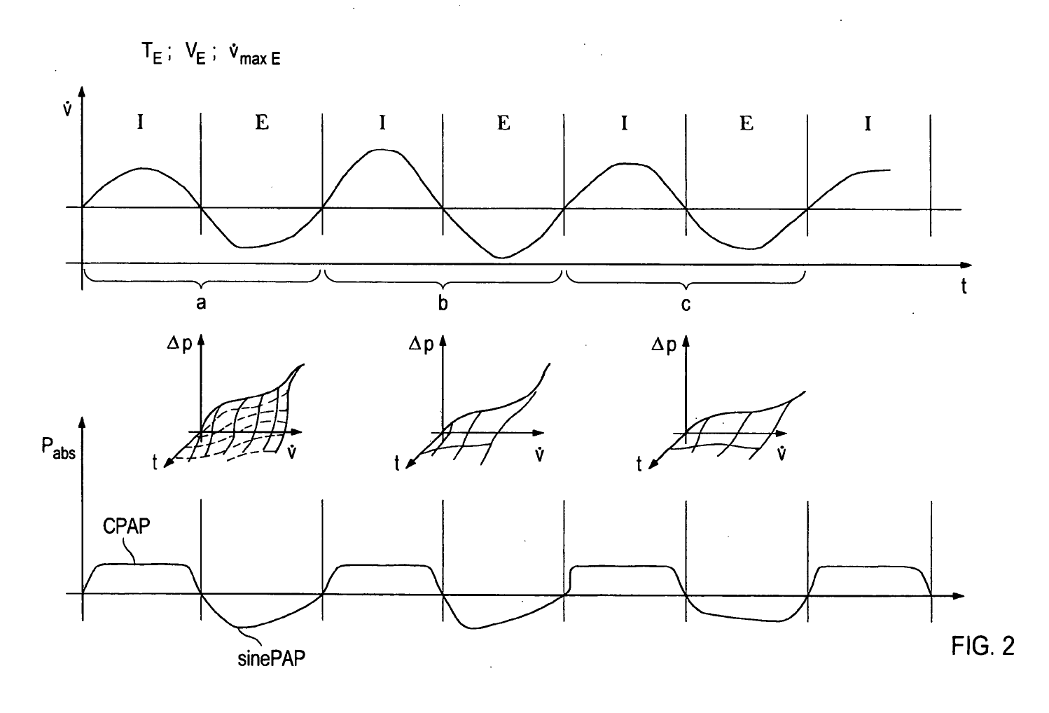

FIG. 2, a sketch for explaining the nonlinear dependency of the breathing gas pressure on the instantaneous breathing gas flow;

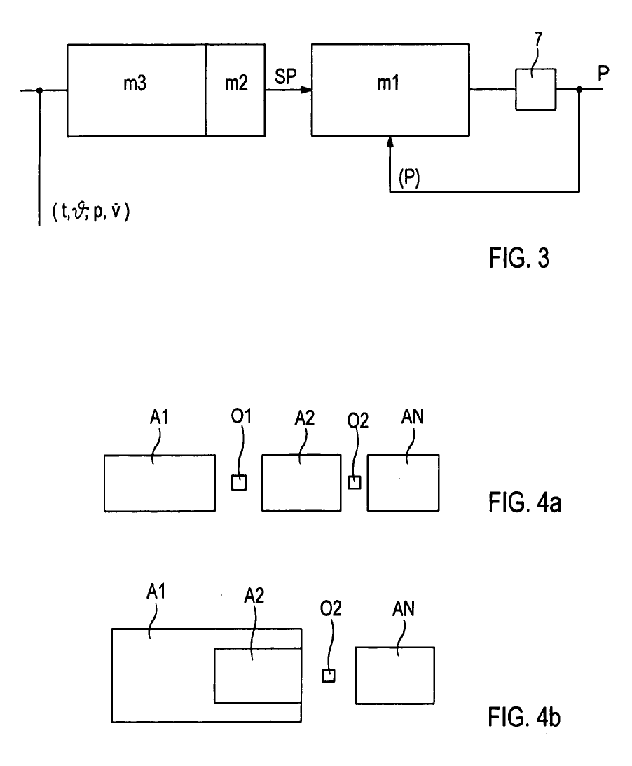

FIG. 3, a schematic illustration for explaining the regulation provisions provided for the pressure adaptation according to the invention;

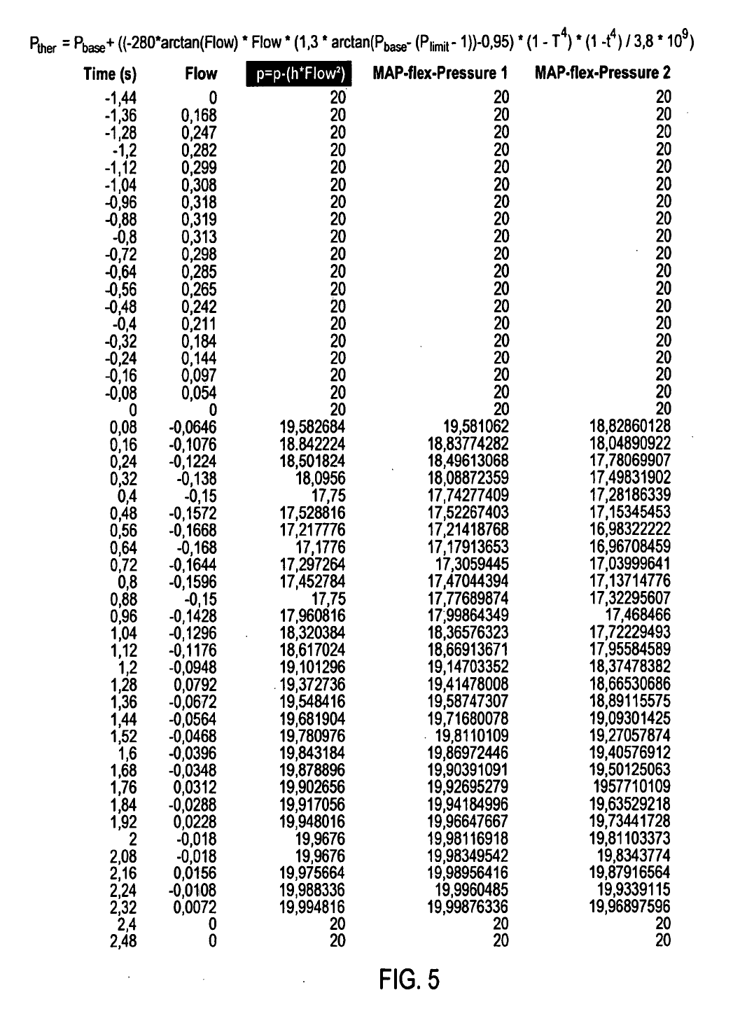

FIG. 4a, a sketch for explaining the makeup of a first variant of the function used for the pressure adaptation according to the invention;

FIG. 4b, a sketch for explaining a further variant of the function used for the pressure adaptation;

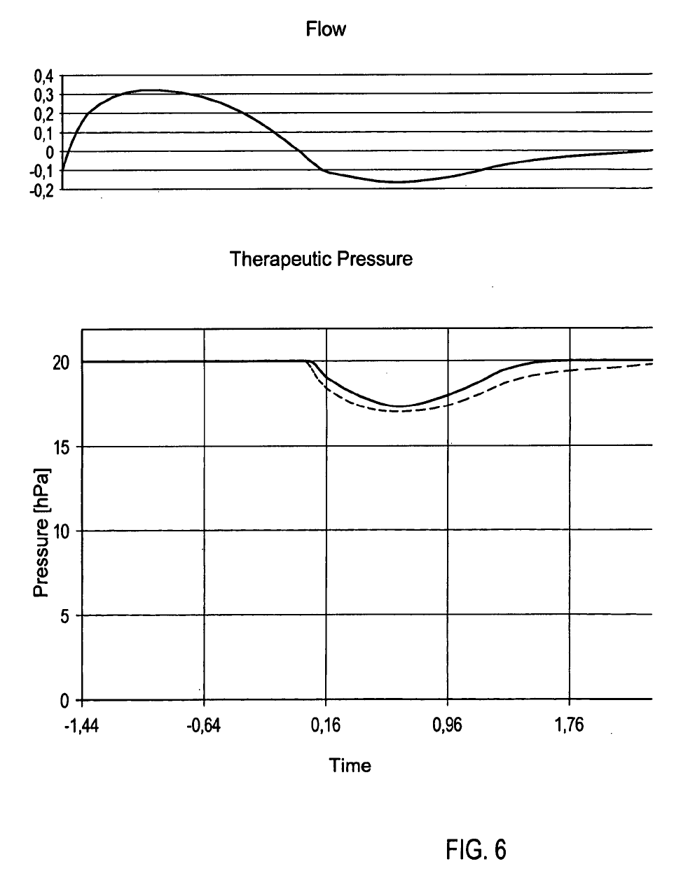

FIG. 5, a data sheet for explaining the pressure values generated using a function according to the invention;

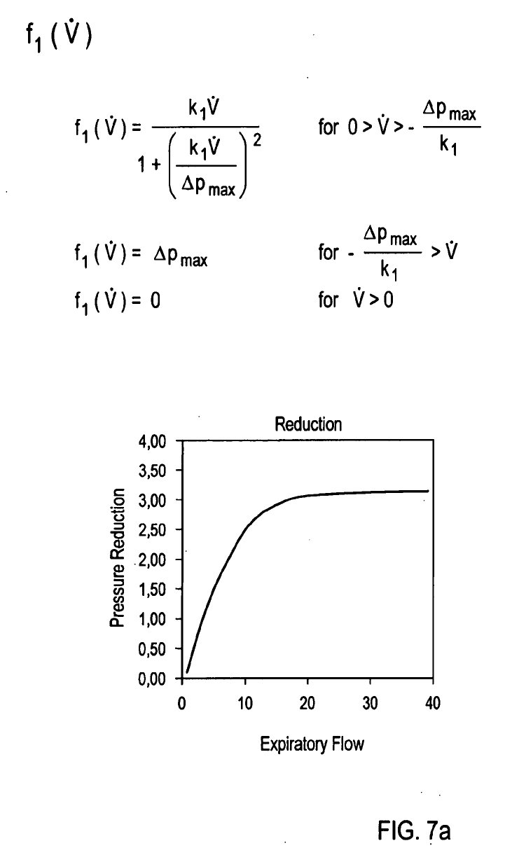

FIG. 6, a graph for illustrating the values of FIG. 5;

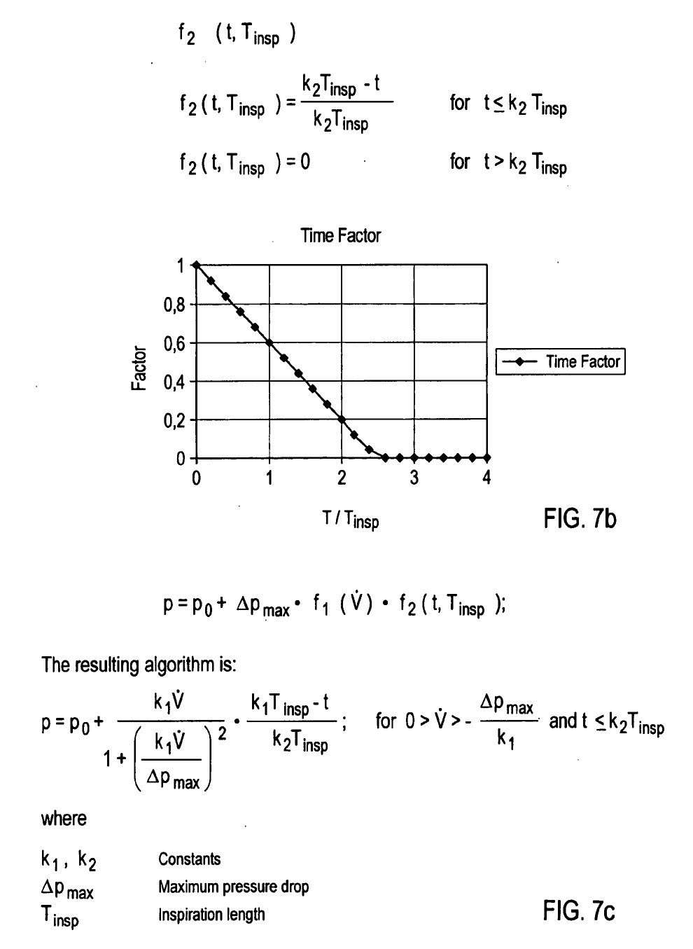

FIG. 7a, a summary, based on a graph, for explaining a function component f1 of a further pressure guidance function;

FIG. 7b, a summary, based on a graph, for explaining a further function component f2 of a further pressure guidance function;

FIG. 7c, a summary in formula form for illustrating the formation of the pressure guidance formula from the arguments f1 and f2.

The schematic illustration in FIG. 1 shows a user 1, on whom a breathing mask 3 is fixed via a headband arrangement 2. The breathing mask 3 in this example is embodied such that it covers the nose region but leaves the mouth region free. It is also possible to embody the breathing mask 3 such that it also covers the oral opening. The deliver of breathing gas can also be done via other kinds of structures, such as mouth insert elements, or merely nose pads seated in the region around the nostrils.

The breathing mask 3 is connected to a device 6 for delivering the breathing gas (in this case, filtered ambient air) via a hose connection plug 4 and a flexible hose 5. The device 6 includes a feeding device, embodied here as a blower 7, which communicates on the intake side with the environment via a suction line 8 and a suction filter device 9.

The blower 7 is connected on the pressure side to a pressure line segment 10. The pressure line segment 10 leads, via a muffler segment, not illustrated in detail, to a hose connection stub 11, to which the flexible hose 5 is detachably coupled.

In the region of the pressure line segment 10, there is a signal pickup device 12 for picking up signals indicative of the breathing gas flow. In the exemplary embodiment shown here, the signal pickup device is embodied in collaboration with a measurement baffle arrangement, and the signal indicative of the breathing gas flow can be picked up in the form of a differential pressure signal, that is, the difference in the pressures upstream and downstream of the measurement baffle arrangement. Signals indicative of the breathing gas flow can also be attained in other ways, for instance on the basis of detecting the motor power drawn, on the basis of acoustical effects, or for instance by means of an optical waveguide that is deflected in a way that is indicative of the flow of breathing gas moving past it.

The blower 7 may be embodied such that the differential pressure built up by the blower 7 between the suction line 8 and the pressure line segment 10 is adjustable by regulating the rpm of an impeller provided in the blower 7. It is also possible to make other provisions for controlling or regulating the differential pressure that exists between the suction line 8 and the pressure line segment 10. Such provisions may in particular take the form of bypass lines or provisions made inside the blower 7.

In the exemplary embodiment shown here, the differential pressure prevailing between the suction line 8 and the pressure line segment 10 is adapted by means of regulating the rpm of an impeller of the blower 7. To that end, a drive device of the blower 7 is connected to a control unit 14 via a triggering line 13. The control unit 14 is preferably embodied such that the pressure regulating concept that is in the final analysis executed by this control unit 14 can be defined in a program-based way by storing suitable program data sets. The control unit 14 is in particular preferably embodied such that by means of it, pressure regulating concepts adapted to the particular therapy intended can be implemented. These pressure regulating concepts can be stored directly in the control unit 14 in suitable memory units 15. It is also possible to embody the memory units 15 as replaceable units, so that the applicable control concept is furnished by means of inserting or docking a corresponding memory unit or circuit unit into or onto the control unit 14. It is also possible to provide the control unit 14 with an interface device, so that the appropriate configuration of the control unit 14 can be brought about by way of temporary connection to a configuration system.

In the exemplary embodiment shown here, a data set is stored in the memory unit 15, and by way of it an adaptation of the breathing gas pressure, applied to the user 1 via the breathing mask 3, is done as defined by a pressure regulating concept that provides at least intermittently alternating pressure levels synchronously with respiration.

These pressure levels can be set in particular for an expiratory phase and optionally also for an inspiration phase, by recourse to a nonlinear pressure guidance function. This nonlinear pressure guidance function is represented for instance as a three-dimensional function f that is dependent on the time t and the instantaneous breathing gas flow v. In accordance with this function f shown here, as a function of the progression of time and of the instantaneous breathing gas flow during an expiratory phase, a pressure reduction and optionally a slight overelevation of pressure at the onset of an inspiration phase can both brought about.

The control unit 14 is furthermore embodied such that besides the signal indicative of the instantaneous breathing gas flow and picked up via the signal pickup device 12, it also takes into account the instantaneously set breathing gas pressure as well as the actually prevailing thermal load, calculated via a model statement, of certain components of the device 6.

In particular, the control unit 14 may be configured such that until a limit value thermal load of the device 6 is reached, the breathing gas pressure regulation is done with relatively highly dynamic regulation, or via a relatively wide pressure variation range. This makes it possible in particular, in a phase when a patient is going to sleep, to attain especially comfortable pressure regulation while fully utilizing the pressure regulation spectrum.

The control unit may be embodied such that first, in the form of a standard configuration, it makes a preferably largely overswing-free regulation of a therapeutic pressure (such as CPAP pressure) intended for the user possible.

Only for certain instances of usage or treatment is the control unit 14 configured for executing more-complicated pressure control concepts. This special configuration can be made such that the control unit 14 is expanded with a control module intended for more-complex calculation of a set-point pressure signal, so that as interface information, only the set-point pressure required by the control module is exchanged. In ascertaining the set-point pressure, it is possible to take properties of specific devices into account, in particular the transmission behavior of the blower 7, so that by means of the specification of the set-point pressure signal, certain transmission properties of the system are already taken into account. In this case, the set-point pressure signal does not correspond to the pressure that is to be finally regulated, but rather to a controlling variable required in advance to attain a required pressure.

As FIG. 2 shows, it becomes possible, on the basis of the configuration according to the invention of the control unit 14, particularly by defining the regulation strategy of the control unit 14 by means of the data set stored in the memory unit 15, to set breathing gas pressure levels that at least in some phases alternate synchronously with respiration.

With recourse to a procedure representing in particular the progression of time, the instantaneous breathing gas flow, and the thermal load of the feeding device provided for delivering the breathing gas, it becomes possible during an expiratory phase to reduce the breathing gas pressure in a way that is perceivable subjectively by the user as pleasant. The pressure reduction can be done such that the relationship of the pressure reduction to the expiratory breathing gas flow is markedly nonlinear in nature, and in particular varies over time. As a result, it becomes possible, especially toward the end of a time phase that is typical for an average expiration cycle, to attain a return to the therapeutic pressure level intended for preventing obstruction. It is also possible to design the function such that toward the end of the expiratory phase, or in the early beginning stage of an inspiration phase, a certain overelevation of pressure above the breathing pressure level otherwise intended is attained.

In the first breathing cycle a shown here, a pressure reduction that is nonlinear with respect to the breathing gas flow is attained during the expiratory phase, based on the function according to the invention. During the breathing cycle 2 shown here, because of the adaptation of the pressure guidance function, nonproportional and markedly nonlinear relations result between the pressure reduction and the instantaneous breathing gas flow.

For the breathing cycle c, for instance on the basis of an already advanced thermal load of the feeding device, the result is a further-changed nonproportional, nonlinear relationship between the breathing gas flow and the reduction in pressure during the expiratory phase.

FIG. 3 serves to illustrate the closed control loop provided according to the invention for adapting the static pressure P, applied to the patient, of the breathing gas. This breathing gas pressure is built up by means of the blower 7. The feeding power of the blower 7 is adapted by means of a control module m1. This control module m1 can form part of a closed control loop with a view to a feedback of the pressure signal P.

A pressure specification signal SP can be delivered to the pressure control module m1 by means of a pilot control module m2. The pilot control module m2 may be embodied such that by means of it, a set-point value, specified by a pressure specification module m3, is generated in a pressure control signal SP that can advantageously be processed in terms of the transmission behavior of the closed control loop that includes the control module m1. The control units, shown here as discrete modules m1, m2, m3, can all be realized, in program-based and intermeshed form, in a single computer device.

However, it is also possible to form the control module m1 such that it is a component of a standard or basic device which permits various possibilities for generating the pressure specification signal SP. For instance, in a basic or standard configuration of the breathing gas delivery device 6 (see FIG. 1), the pressure specification signal SP can be adjusted by the user using a simple input device.

In the case of retrofitting or equipping the device 6, the configuration of the control unit 14 or of the control unit 15 can be varied in a program-based way. It is also possible to equip the control unit 14 with additional signal- or data-processing or data storage medium hardware, in order to furnish the control pressure signal SP.

By means of the pressure specification module m3, in particular a signal indicative of the instantaneous breathing gas flow, which can be obtained for instance via the signal pickup device 12 shown in FIG. 1, is processed. Also by means of the module m3, information about the instantaneous thermal load of the device 6 and the pressure p applied to the patient at that moment as well as time information can be processed. The time information and optionally also the information about the thermal state of the device can be furnished directly in the module m3 by means of clocking or timer devices. The thermal load can also be detected by means of temperature detecting devices provided in the region of the device 6, or also via a model statement in the region of the module m3. For detecting the thermal load of the device 6 or for estimating the thermal load, it is also possible to evaluate other information or signals that can be picked up in the region of the device. In particular, it is possible to ascertain information about the power drawn by the blower for ascertaining the thermal load of the blower motor, or to ascertain the power stage provided for triggering the blower motor. Such information can be obtained from the pressure specification signal SP, the intermediate results generated to attain the pressure specification signal SP, or signals for triggering the power stage.

The control module m1 can be embodied such that it triggers a blower motor such that the blower motor causes the impeller coupled with it to rotate at a speed at which a required breathing gas pressure is achieved. The changes in the blower rpm can be set by means of a defined setting of the power delivered to the driving motor. To achieve especially fast pressure changes, it is possible optionally, via the control module m1, to operate the motor such that by it, a braking moment that temporarily brakes the impeller device or the masses otherwise moved is generated. It is also possible via the control module m1 to realize motor triggering operations at which, at least intermittently, essentially no power is delivered to the motor, and the blower brakes itself in the process, particularly under the influence of the breathing gas pressure. This type of pressure reduction proves advantageous with a view to the least possible thermal load on the motor.

Corresponding concepts for varying the breathing gas pressure may optionally be selected as a function of the instantaneous thermal load on the feeding device or an associated power stage. For instance, in device states in which a high thermal load or an at least estimated high thermal load prevails, it is possible in particular to make the pressure changes or rpm changes of the impeller device of the blower in such a way that an Impermissibly great further increase in the thermal load is not to be expected.

In the event that the variation of the breathing gas pressure applied to the patient is brought about in some other way than by varying the impeller rpm of a blower impeller, then by means of the control module m1 a corresponding control structure, such as a bypass valve or other kind of control device, can be triggered.

The nonlinear function, executed according to the invention in the region of the pressure specification module m3, for ascertaining an outcome that is definitive for the pressure applied to the patient can be embodied such that it has a plurality of arguments A1, A2, . . . , AN linked together by means of operators O1, O2. The argument A1 may be trigonometric function, in particular, a sine, cosine or arc tangent function, whose angular or axial increment takes into account a parameter that reflects the instantaneous breathing gas flow v. Via the argument A2, a timing circuit can be realized by which a desired attenuation of the effects of the argument A1 is made possible with increasing progression of time, in particular the time that has progressed since the end of the preceding inspiration phase.

The argument AN can serve to reflect the instantaneously prevailing thermal load of the device, or the estimated thermal load of the device. The operators O1, O2 can be realized in particular as multiplication operators. The entire pressure guidance function, realized by means of the arguments A1, A2, . . . , AN and the associated operators O1, O2, . . . , ON can optionally be broken down into a series and executed with adequate approximation in the region of the pressure specification module m3.

As suggested in FIG. 4b, it is also possible to design the argument A1 such that it reflects a predetermined nonlinear relationship between the instantaneous breathing gas pressure and the instantaneously prevailing, expiratory breathing gas flow. To that end, it is possible to provide at least one further argument, in particular the time argument A2, as an increment of the argument A1. The argument AN can be linked functionally to the argument A1 via the operator O2, particularly with O2 as a multiplier. It is also possible to incorporate the argument AN, as a further increment of the argument A1, into the function intended for specifying the breathing gas pressure.

FIG. 5 shows a pressure curve, on the basis of a nonlinear function of the makeup shown in FIG. 4a, in which the arguments A1 and A2 are represented by arc tangent functions, and the operator O1 is a multiplier.

FIG. 6 shows a therapeutic pressure calculated on the basis of the function indicated. During the inspiration phase, the therapeutic pressure is kept at a predetermined value, here for instance shown as 20 mbar. During an expiratory phase, the therapeutic pressure is reduced; the reduction is correlated in a nonlinear way with the breathing gas flow that prevails during the expiratory phase.

In FIGS. 7a, 7b, and 7c, a further function for ascertaining a therapeutic pressure, reduced to different pressure levels during an expiratory phase, is shown. The function shown here also corresponds in its makeup to the scheme sketched in FIG. 4a. The argument f1 is a nonlinear argument. The argument f1 is used to take the instantaneous breathing gas flow into account. The argument f2 is used to incorporate a timing member. By means of the argument f1, a relationship between the expiratory breathing gas flow and the associated pressure reduction is achieved, as can be seen from the drawing a) incorporated into FIG. 7a.

By means of the function f2 shown in FIG. 7b, an attenuation of the pressure reduction, attainable by the argument f1, is attained as a function of the time that has elapsed since the end of an inspiration phase. In the function shown here, this timing element has the suppressing effect that can be seen from the drawing b) incorporated into FIG. 7b.

The breathing gas pressure p required is found from the pressure guidance function shown in FIG. 7c.

The invention is not limited to the pressure guidance functions and exemplary embodiments described above. In particular, it is also possible for the function intended for determining the set-point breathing gas pressure or a value to be specified to a closed pressure control loop to be parametrized such that by means of it, numerous pressure guidance characteristics that deviate from the functions described above can be achieved.

It is also possible to also consider the determination the pressures that prevail during the inspiration phase, the width of the pressure reduction interval, the breathing phase detection, the detection of leakage states, and other properties of the functions that are definitive for determining the set-point pressure, by means of additional provisions that are based on signal processing. In particular, it is possible to adapt the peak pressure and the minimum pressure on the basis of signal evaluation results that are indicative of the physiological state of the user.

The present invention can be used as described below:

When an obstructive sleep apnea patient is in a sleep laboratory, an assessment is made as to whether a possibility exists for treatment based on overpressure breathing support. For this overpressure breathing support, a suitable therapeutic pressure can be ascertained during the stay in the sleep laboratory. For performing the overpressure respiration at home, a breathing gas delivery system is made available to the patient that includes a basic device, an air humidifier, a hose, and a breathing mask arrangement.

The basic device is connected to a configuration system via an interface device and configured to suit the patient in the area of the sleep laboratory. In this configuration, it becomes possible to adjust the pressure control properties of the basic device in such a way that the pressure guidance of the breathing gas is done in accordance with the pressure guidance concept proposed according to the invention. The patient can then use the thus-configured device at home.

The device according to the invention is distinguished in that the breathing gas pressure is adjusted largely in alternation, synchronously with the breathing. During the expiratory phases, the breathing gas pressure is adjusted on the specification of a pressure guidance value, which is calculated by means of a nonlinear relationship between the time t that has elapsed since the end of the preceding expiratory phase and the instantaneous breathing gas flow. If the thermal status of the device could become critical in terms of regulating the feeding power of the feeding device in a way that requires a relatively large amount of power, then the regulating strategy can automatically be modified, taking actual or estimated load figures into account, with the goal of pressure guidance that draws reduced power or that releases less heat.

1. A device for providing a breathing gas at alternating breathing gas pressure levels that at least in some phases are above the ambient pressure, having:
a feeding device for feeding the breathing gas,
a pressure adjusting device for triggering the feeding device, such that the feeding device, with recourse to a set-point breathing gas pressure signal, provides the breathing gas at a set-point breathing gas pressure level,
a pressure specification device for generating the set-point breathing gas pressure signal that is definitive with regard to the set-point breathing gas pressure level, and
parameter-determination means for providing parameters representative at least of the instantaneous breathing gas pressure p, the progression of time t, and the instantaneous breathing gas flow v,
wherein the pressure specification device includes a computer circuit, and the computer circuit is configured such that it adjusts the set-point breathing gas pressure level as a function of the parameters provided by the parameter-determination means, in such a manner that at least in the expiratory phase, an adjustment of the breathing gas pressure to a pressure level is effected which is calculated on the basis of a dynamic or nonlinear pressure guidance function, which as such takes parameters into account that are indicative of the breathing gas flow and the progression of time and as a result, the tendency to lowering the breathing gas pressure in conjunction with the extent of the breathing gas flow decreases with increasing progression of time.

2. The device of claim 1, characterized in that the parameter V_{I} is provided by the parameter-determination means, and the parameter V_{I} corresponds to the inspiration volume during the preceding breath, or to the mean inspiration volume of a plurality of preceding breaths.

3. The device of claim 1, characterized in that the parameter Vₘₐₓ is provided by the parameter-determination means, and the parameter Vₘₐₓ corresponds to the inspiration flow value during the preceding breath, or to the mean inspiration flow value of a plurality of preceding breaths.

4. The device of claim 1, characterized in that a parameter T indicative of the thermal load of a blower or of other electrical components is provided by the parameter-determination means.

5. The device of claim 1, characterized in that the thermal load is estimated on the basis of a model statement.

6. The device of claim 1, characterized in that the device is operated such that load limit values are adhered to in a permissible way.

7. The device of claim 1, characterized in that the pressure modulation dynamics are adapted on the specification of a ramp statement, such that during a beginning ramp phase, greater pressure reductions are attainable than toward the end of the ramp phase.

8. The device of claim 1, characterized in that the configuration of the computer circuit can be accomplished by a data storage medium.

9. The device of claim 8, characterized in that the data storage medium is designed as a memory card.

10. The device of claim 1, characterized in that the pressure guidance is effected such that the pressure level spacing is defined as a function of the average or peak pressure.

11. The device of claim 10, characterized in that the allowable level spacing likewise increases with an increase in the minimum pressure level.

12. The device of claim 1, characterized in that the pressure guidance function is designed as an arc tangent, sine, cosine, root, and/or exponential function.

13. The device of claim 1, characterized in that the pressure guidance function is adapted such that its first derivation (dv/dt²) has a maximum in the range of average breathing gas flows.

14. A device for providing a breathing gas at alternating breathing gas pressure levels that at least in some phases are above the ambient pressure, having:
a feeding device for feeding the breathing gas,
a pressure adjusting device for triggering the feeding device, such that the feeding device, with recourse to a set-point breathing gas pressure signal, provides the breathing gas at a set-point breathing gas pressure level,
a pressure specification device for generating the set-point breathing gas pressure signal that is definitive with regard to the set-point breathing gas pressure level, and
parameter-determination means for providing parameters representative at least of the instantaneous breathing gas pressure p, the progression of time t, and the instantaneous breathing gas flow v,
wherein the pressure specification device includes a computer circuit, and the computer circuit is configured such that it adjusts the set-point breathing gas pressure level as a function of the parameters provided by the parameter-determination means, in such a manner that at least in the expiratory phase, an adjustment of the breathing gas pressure to a pressure level is effected which is calculated on the basis of a pressure guidance function, which as such takes parameters into account that are indicative of the breathing gas flow and the progression of time and as a result, the tendency to lowering the breathing gas pressure in conjunction with the extent of the breathing gas flow decreases with increasing progression of time.

15. A device for providing a breathing gas at alternating breathing gas pressure levels that at least in some phases are above the ambient pressure, having:
a feeding device for feeding the breathing gas,
a pressure adjusting device for triggering the feeding device, such that the feeding device, with recourse to a set-point breathing gas pressure signal, provides the breathing gas at a set-point breathing gas pressure level,
a pressure specification device for generating the set-point breathing gas pressure signal that is definitive with regard to the set-point breathing gas pressure level, and
parameter-determination means for providing parameters representative at least of the instantaneous breathing gas pressure p, the progression of time t, and the instantaneous breathing gas flow v,
wherein the pressure specification device includes a computer circuit, and the computer circuit is configured such that it adjusts the set-point breathing gas pressure level as a function of the parameters provided by the parameter-determination means, in such a manner that at least in the expiratory phase, an adjustment of the breathing gas pressure to a pressure level is effected which is calculated on the basis of a pressure guidance function, which as such takes parameters into account that are indicative of the thermal load of the device and as a result, the tendency to lowering the breathing gas pressure decreases in conjunction with the level of thermal load.

16. A method for providing a breathing gas at alternating breathing gas pressure levels that at least in some phases are above the ambient pressure, by using:
a feeding device for feeding the breathing gas,
a pressure adjusting device for triggering the feeding device, such that the feeding device, with recourse to a set-point breathing gas pressure signal, provides the breathing gas at a set-point breathing gas pressure level,
a pressure specification device for generating the set-point breathing gas pressure signal that is definitive with regard to the set-point breathing gas pressure level, and
parameter-determination means for providing parameters representative at least of the instantaneous breathing gas pressure p, the progression of time t, and the instantaneous breathing gas flow v,
in which the set-point breathing gas pressure level is adjusted as a function of the parameters provided by the parameter-determination means, in such a manner that at least in the expiratory phase, an adjustment of the breathing gas pressure to a pressure level is effected which is calculated on the basis of a pressure guidance function, which as such takes parameters into account that are indicative of the breathing gas flow and the progression of time and as a result, the tendency to lowering the breathing gas pressure in conjunction with the extent of the breathing gas flow decreases with increasing progression of time.
